(19) United States
(12) Patent Application Publication
(10) Pub. No.: US 2019/0257208 A1
(43) Pub. Date: Aug. 22, 2019

(54) Unitary Turbine Blade and Method of Manufacture Thereof

(71) Applicant: Novatek IP, LLC, Provo, UT (US)

(72) Inventor: Scott Dahlgren, Alpine, UT (US)

(21) Appl. No.: 15/900,170

(22) Filed: Feb. 20, 2018

(51) Int. Cl. F01D 5/34; F01D 5/28; F01D 5/14

(52) U.S. Cl. CPC F01D 5/34; F01D 5/28; F01D 5/141; B23D 57/0007; F05D 2300/506; F05D 2300/224; F05D 2230/10

(57) ABSTRACT

A rotary-mechanical device, capable of extracting energy from a fluid flow and converting it into rotational motion, may comprise a turbine rotor. This turbine rotor may have an exterior surface extending between two opposing sides. The exterior surface may be formed of a plurality of straight lines, each spanning from a first edge, bordering one of the sides, to a second edge, bordering the opposite side. Each of the straight lines may be disposed in an individual plane running perpendicular to a rotational axis of the turbine rotor, wherein the rotational axis is positioned equidistant between the two sides. A turbine rotor of this type may be formed from a unitary mass by degrading the mass with a wire that may be translated and rotated relative to the mass during degradation.

### BACKGROUND

A turbine is a mechanical device capable of extracting energy from a fluid flow and converting it into rotational motion. This rotational motion may be used directly, such as to open or close a valve, or may be further converted into electricity by combining the turbine with a generator. Common turbine designs comprise a shaft with blades extending radially therefrom. Fluid moving past the blades may act thereon such that the blades impart rotational motion to the shaft.

When extracting energy from an abrasive fluid or a fluid carrying abrasive particles turbines, and especially turbine blades, may experience significant wear. To reduce this wear specialized abrasion resistant materials or coatings may be used to form the turbine or portions thereof. Commonly available abrasion resistant materials, however, may be difficult to manufacture into desirable turbine geometries. This is generally true because abrasion resistant materials are often resistant to machining as well.

### BRIEF DESCRIPTION

A turbine rotor may be formed from a unitary mass of abrasion resistant material by engaging the unitary mass with a wire capable of degrading the material. One example of a wire capable of degrading abrasion resistant material may be an electrical discharge machining wire, with a current passing therethrough. An abrasion resistant material capable of degradation by electrical discharge machining may be polycrystalline diamond comprising a metallic catalyst therein.

In order to form a rotor shape, the wire may engage the mass to form an exterior surface spanning between two opposing side surfaces. While engaging, the wire may be manipulated so as to form inverse airfoil shapes on the opposing side surfaces. Additionally, to form a convoluted shape, the mass may be rotated about a rotational axis thereof while being engaged by the wire.

Through this technique, a turbine rotor may be fabricated comprising an exterior surface formed of a plurality of straight lines. Each of the straight lines may traverse from one edge to another, the edges positioned equidistant on either side of a rotational axis. Each of the straight lines may also be disposed within an individual plane perpendicular to the rotational axis.

### DRAWINGS

FIGS. 1-1 and 1-2 are an orthogonal side view and an orthogonal front view, respectively, of an embodiment of turbine rotor.

FIG. 2-1 is an orthogonal view of an embodiment of an electrical discharge machining process before cutting has begun. FIG. 2-2 is a perspective view of an embodiment of a generally cylindrical mass formed of abrasion resistant material.

FIG. 3-1 is an orthogonal view of an embodiment of an electrical discharge machining process performing a first cut. FIG. 3-2 is a perspective view of an embodiment of a generally cylindrical mass cut into two parts.

FIG. 4-1 is an orthogonal view of an embodiment of an electrical discharge machining process cutting a slot. FIG. 4-2 is a perspective view of an embodiment of a mass with a slot cut therein.

FIG. 5-1 is an orthogonal view of an embodiment of an electrical discharge machining process performing a second cut. FIG. 5-2 is a perspective view of an embodiment of a turbine rotor cut from a mass.

FIGS. 6-1 and 6-2 show a perspective view and an orthogonal top view, respectively, of an embodiment of a holder capable of securing a turbine rotor to a shaft. FIGS. 6-3 and 6-4 show orthogonal side views of embodiments of a turbine rotor adjacent a holder and secured to a holder, respectively.

FIG. 7 shows an orthogonal side view of an embodiment of a turbine rotor secured to a holder and adjacent a bearing.

FIGS. 8-1, 8-2, 8-3 and 8-4 show various views of embodiments of two turbine rotors mated together and sharing a rotational axis.

### DETAILED DESCRIPTION

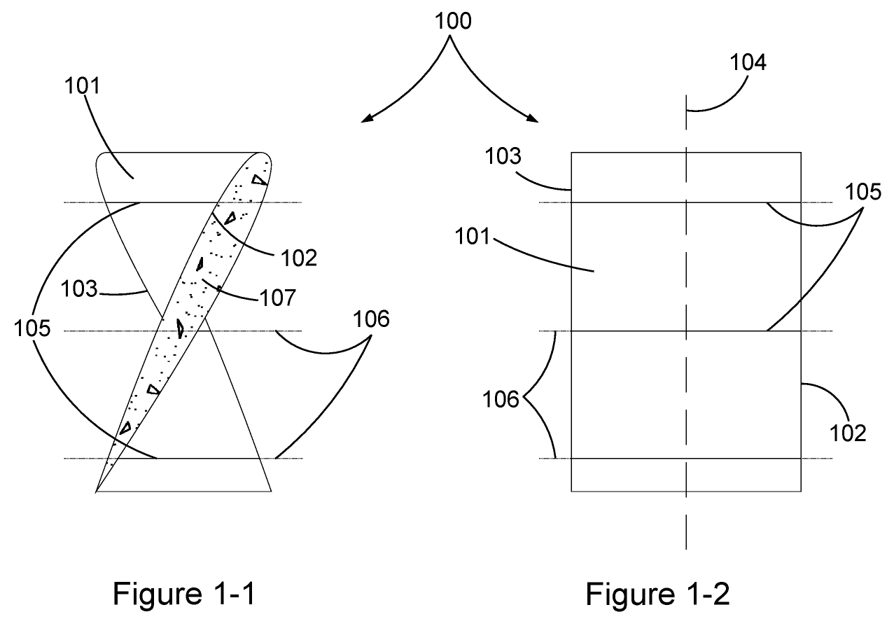

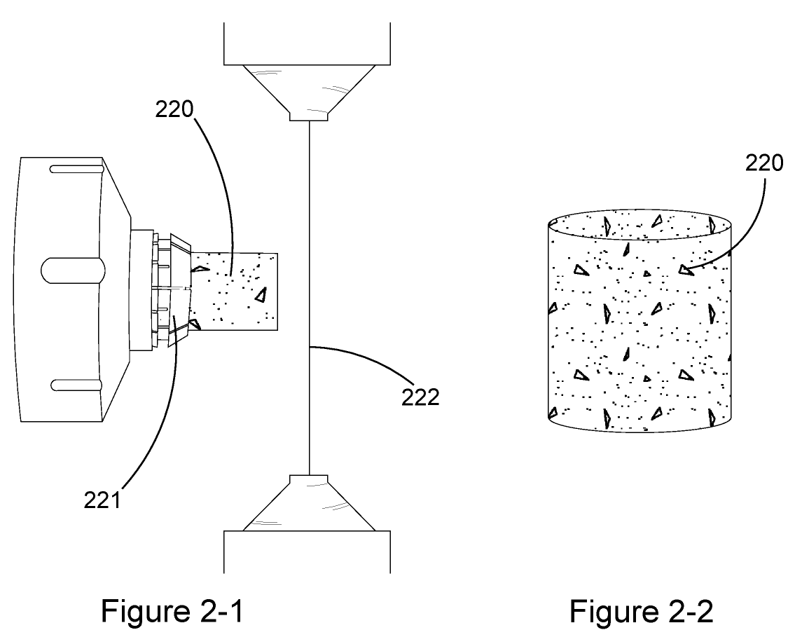

FIGS. 1-1 and 1-2 show an embodiment of a turbine rotor 100 comprising an exterior surface 101 spanning from a first edge 102 to an opposing second edge 103. The first and second edges 102, 103 may be equally spaced on either side of a rotational axis 104 passing through a center of the turbine rotor 100. The exterior surface 101 may be formed of a plurality of straight lines 105 (only a few representative examples shown) stretching from the first edge 102 to the second edge 103. Each of these straight lines 105 may be disposed within an individual plane 106 lying perpendicular to the rotational axis 104.

In the embodiment shown, each of the straight lines 105 is of equal length, however, other configurations are also possible. As also shown in this embodiment, each of the straight lines 105 may be convoluted about the rotational axis 104 relative to adjacent straight lines such that the exterior surface 101 itself is convoluted.

Both the first edge 102 and the second edge 103 border respective side surfaces of the turbine rotor 100. Specifically, the first edge 102 borders a first side surface 107 forming an airfoil shape visible in FIG. 1-1. The second edge 103 borders a second side surface (hidden in FIG. 1-1) also forming an airfoil shape. Because the exterior surface 101 is formed of a plurality of straight lines 105 each disposed within a plane 106 perpendicular to the rotational axis 104, the second side surface may form an airfoil shape substantially inverse of the airfoil shape of the first side surface 107. In this configuration, if the turbine rotor 100, shown in FIG. 1-1, were to be rotated 180° about its rotational axis 104 it would look similar to how it is now depicted, with the airfoil shape of the second side surface taking the position that the airfoil shape of the first side surface 107 holds.

Geometries similar to those shown in FIGS. 1-1 and 1-2, specifically with convoluted airfoil forms, may provide an uncomplicated structure capable of being machined from a unitary mass of abrasion resistant material. To machine such a geometry, it may be advantageous to start with a generally cylindrical mass 220, as shown in FIGS. 2-1 and 2-2, formed of an abrasion resistant material comprising some electrical conductivity. It has been found that superhard materials (materials with a hardness value exceeding 40 gigapascals when measured by the Vickers hardness test) may be sufficiently abrasion resistant for many applications. One such superhard material that is also electrically conductive is polycrystalline diamond comprising some metallic catalyst therein.

The mass 220 may be secured within a chuck 221 capable of rotating the mass 220. The chuck 221 may also be capable of translating the mass 220 relative to a wire 222. In alternative embodiments, wire guides may rotate or translate relative to a chuck to produce similar results.

The wire 222 may be capable of degrading the abrasion resistant material when engaged therewith. For example, the wire 222 and mass 220 may each form an electrode as part of an electrical discharge machining (EDM) process. In a common EDM process, electrical discharges between a wire and a workpiece may cut the workpiece to a desired shape.

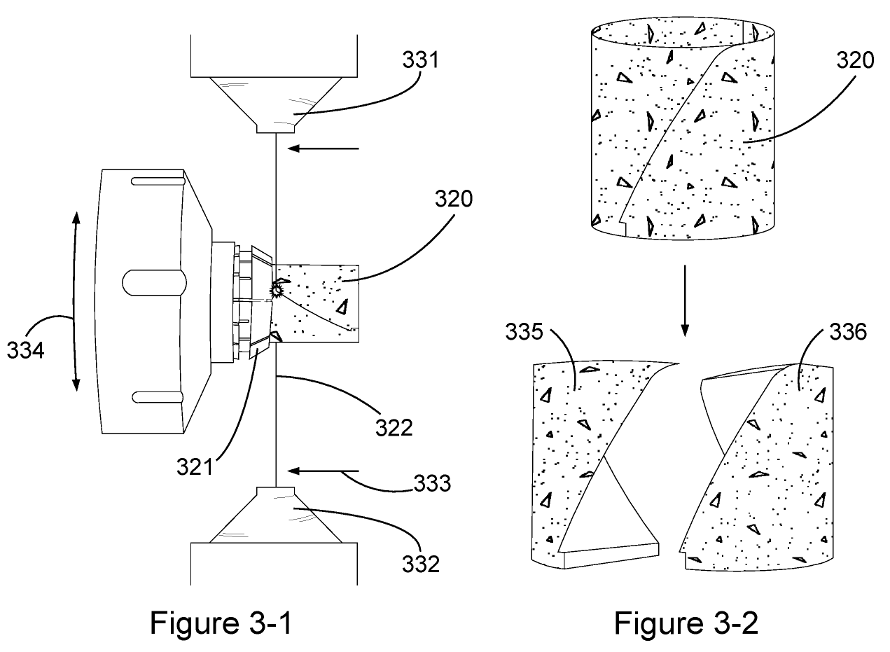

FIG. 3-1 shows an embodiment of a wire 322, forming part of an EDM process, engaging a mass 320 to make a first cut. While cutting, the wire 322 may be fed between two guides 331, 332 such that fresh material is continuously exposed. During the first cut, the two guides 331, 332 may travel 333 relatively toward the mass 320. The mass 320 may initially comprise a generally cylindrical shape, as shown in FIG. 3-2. The wire 322 may engage the mass 320 at one end of the generally cylindrical shape and cut roughly half of an airfoil shape before exiting at an opposite end of the generally cylindrical shape. While this is occurring, the mass 320 may be rotated 334 about an axis thereof by a chuck 321 such that the airfoil shape becomes convoluted about the axis. After the wire 322 exits the mass 320, the mass 320 may be split into two parts as shown in FIG. 3-2. At this point, the part 335 shown on the left may be discarded while work continues on the part 336 shown on the right.

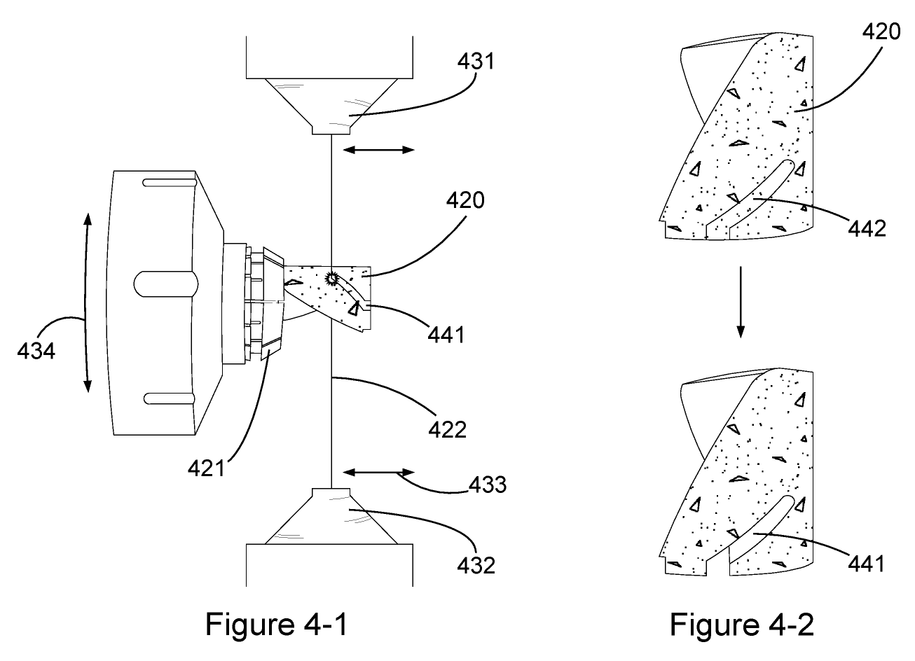

In some embodiments, a slot may then be cut in one end of the mass 320 to aid in affixing the mass 320 to a rotary shaft. FIG. 4-1 shows an embodiment of an EDM wire 422 cutting a slot 441 in a mass 420. Guides 431, 432 may move the wire 422 in a back-and-forth motion 433 and the mass 420 may be rotated 434 by a chuck 421 while cutting. Material 442 within the slot 441 may be slid out and removed after cutting is complete, as shown in FIG. 4-2.

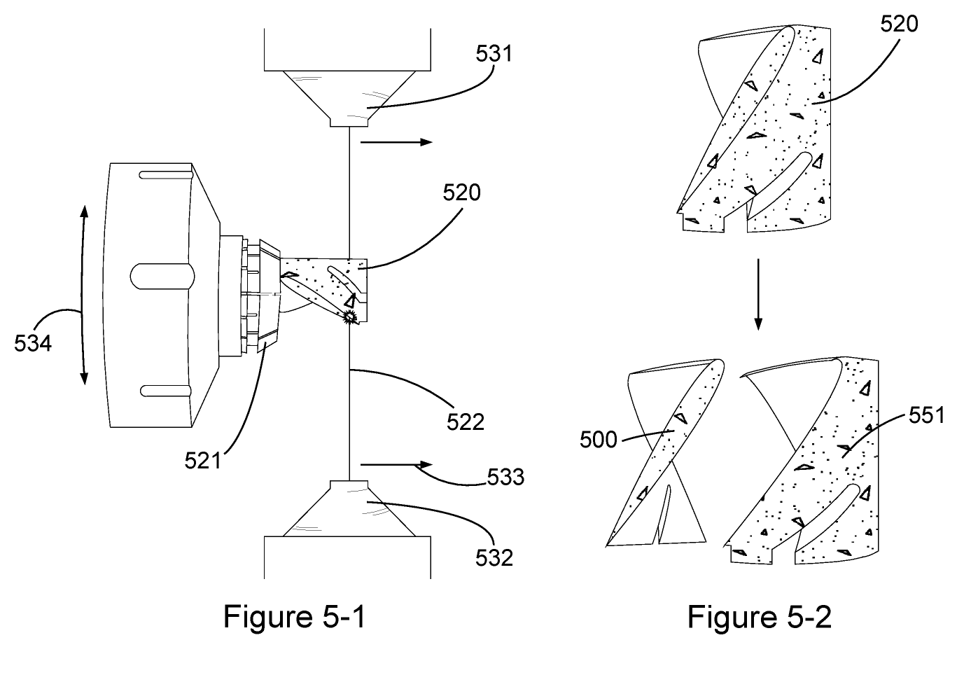

FIG. 5-1 shows an embodiment of an EDM wire 522 making a second cut to a mass 520. While cutting, two guides 531, 532 may move 533 the wire 522 away from a chuck 521 rotating 534 the mass 520. Upon finishing the cut, the wire 522 may exit the mass 520 at an end thereof where it initially began. This second cut may complete the airfoil shape commenced earlier. When the cut is complete, a turbine rotor 500, shown on the left of FIG. 5-2, may be removed from a remainder 551 of the mass 520, shown on the right.

By this method, a wire may cut a turbine rotor from a solid mass of abrasion resistant material. Furthermore, by translating and rotating the wire and mass relative to one another while cutting, a convoluted airfoil shape may be formed. As the wire always forms a straight line, an exterior surface of the turbine rotor may also comprise a plurality of straight lines. Sides of the turbine rotor, positioned on opposing extremities of the exterior surface, may comprise the original surfaces of the abrasion resistant mass. If the solid mass starts as a generally cylindrical form, then these original surfaces found on opposing sides of the finished turbine rotor may comprise convex curvatures. Each of the convex curvatures may comprise a center matching the rotational axis of the turbine rotor such that points along the edges and opposing sides are equidistant from the axis.

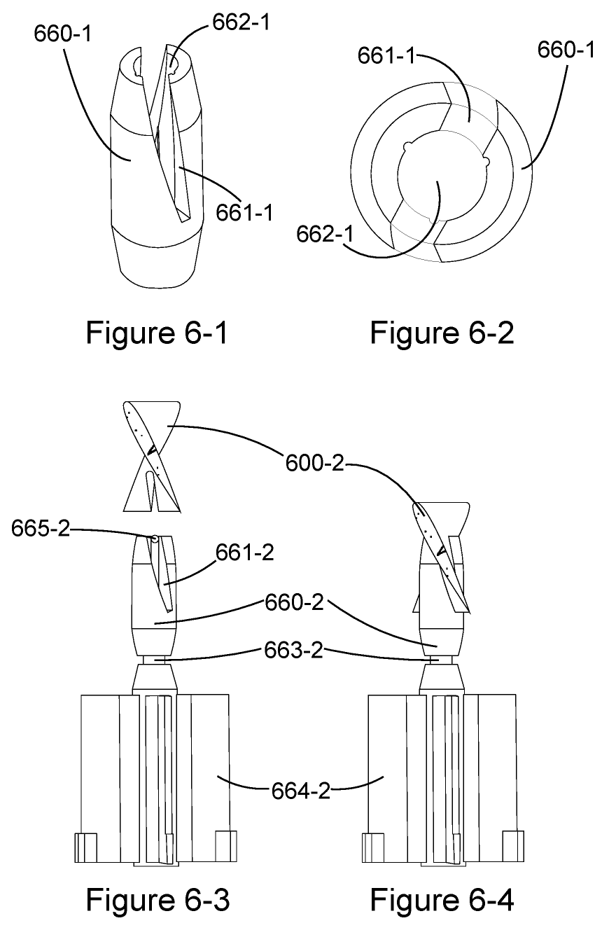

To transmit rotational energy from such a turbine rotor to another device, such as a generator for electricity production, a shaft may be attached to a base of the turbine rotor and aligned with a rotational axis thereof. This shaft may be secured to an exterior surface of the turbine rotor by a holder, disposed on one end of the shaft. FIGS. 6-1 and 6-2 show an embodiment of a holder 660-1 capable of securing a turbine rotor to a shaft. Such a holder may be machined from carbide or another suitably wear-resistant material. The holder 660-1 may comprise a convoluted slot 661-1 on one end thereof and a cylindrical cavity 662-1 on another. In the embodiment shown, the cylindrical cavity 662-1 passes completely through the holder 660-1, however this is not necessary.

Another embodiment of a holder 660-2 is shown in FIGS. 6-3 and 6-4. A shaft 663-2 may fit within a cylindrical cavity of the holder 660-2. In the embodiment shown, the shaft 663-2 leads to an electrical generator 664-2. In alternate embodiments, however, a shaft of this type may transmit rotational motion for other uses, such as to open or close a valve.

A convoluted slot 661-2 within the holder 660-2 may comprise an interior surface generally mating with an exterior surface of a turbine rotor 600-2. The turbine rotor 600-2 may be slid into the slot 661-2 to be secured in the holder 660-2 and to the shaft 663-2. In the embodiment shown, a ball bearing 665-2 is disposed within the slot 661-2. In some situations a ball bearing of this type may aid in reducing wear between a turbine rotor and a slot.

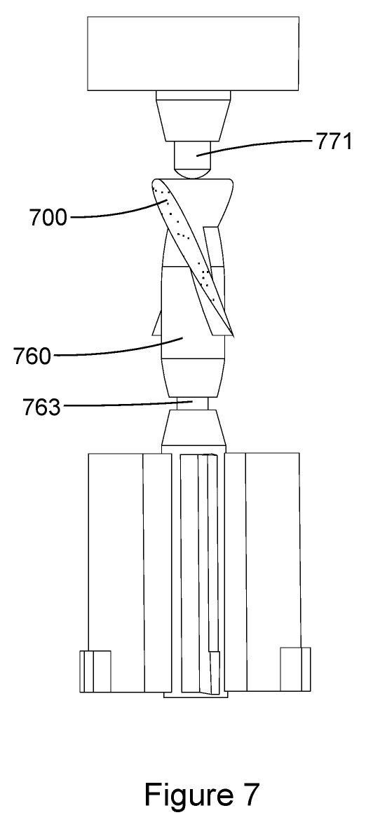

FIG. 7 shows an embodiment of a turbine rotor 700 secured to a shaft 763 via a holder 760. A bearing 771 may be positioned opposite from the shaft 763 and holder 760 such that it restricts axial translation of the turbine rotor 700 away from the shaft 763 and holder 760. The bearing 771 may comprise a geometry and be positioned such that it forms a substantially point contact with an exterior surface of the turbine rotor 700. This point contact may be located on a rotational axis of the turbine rotor 700. The small surface area of the point contact may reduce friction experienced by the turbine rotor 700 from the bearing 771. Furthermore, having a single bearing, rather than bearings on either side of a turbine rotor, may allow for a finer gap between the bearing and turbine rotor. This is because it may not be necessary to align two bearings across from one another. This finer gap may allow the bearing 771 to ride against the turbine rotor 700 on a fluid layer within the gap without fluid exiting the gap.

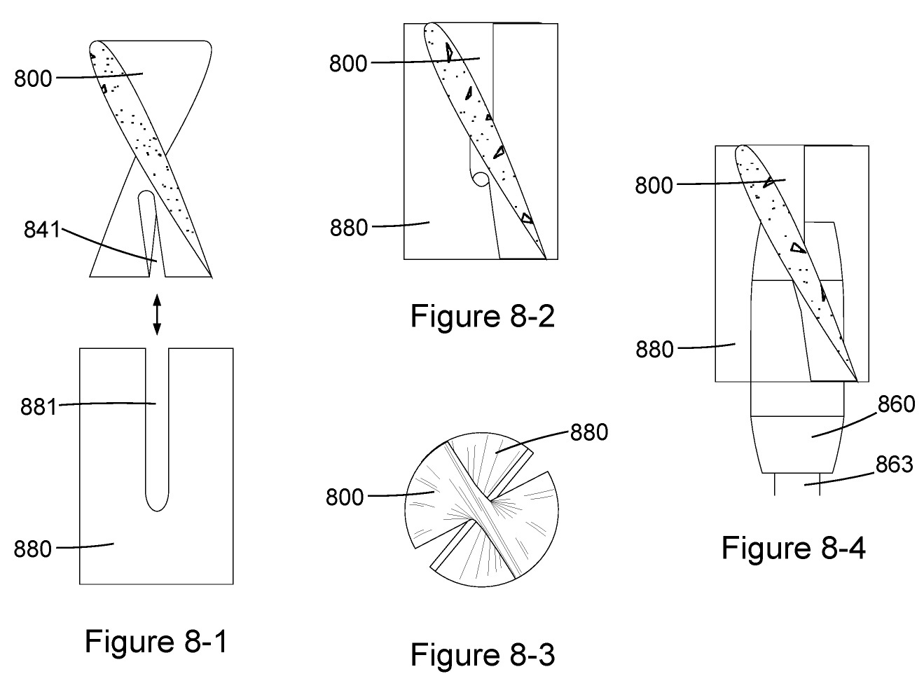

In some embodiments, two turbine rotors, each comprising similar characteristics and manufactured by methods similar to those described previously, may be mated together such that they rotate as one. For example, FIG. 8-1 shows an embodiment of a first turbine rotor 800 comprising a slot 841 disposed in a base portion thereof. FIG. 8-1 also shows an embodiment of a second turbine rotor 880 comprising a slot 881 disposed in a crown portion thereof. The two slots 841, 881 may fit together as shown in FIGS. 8-2 and 8-3 such that the first turbine rotor 800 and second turbine rotor 880 share a common rotational axis. FIG. 8-4 shows the first and second turbine rotors 800, 880 mated together and held by a holder 860 capable of securing the turbine rotors 800, 880 to a shaft 863.

Whereas certain embodiments have been described in particular relation to the drawings attached hereto, it should be understood that other and further modifications apart from those shown or suggested herein, may be made within the scope and spirit of the present disclosure.

1. A rotor element, comprising:
a first edge, a second edge and a rotational axis therebetween; and
an exterior surface spanning from the first edge to the second edge, formed from a plurality of straight lines; wherein
each of the straight lines is disposed in a plane perpendicular to the rotational axis.

2. The rotor element of claim 1, wherein all points along the first edge and second edge are equidistant from the axis.

3. The rotor element of claim 1, wherein the first edge and second edge each border unique surfaces, and all points on the unique surfaces are equidistant from the axis.

4. The rotor element of claim 1, wherein each of the straight lines is of equal length.

5. The rotor element of claim 1, wherein the exterior surface is convoluted about the rotational axis.

6. The rotor element of claim 1, wherein the first edge and second edge comprise inverse geometries of each other.

7. The rotor element of claim 1, wherein both the first edge and the second edge comprise airfoil shapes.

8. The rotor element of claim 1, formed of a unitary mass.

9. The rotor element of claim 8, wherein the unitary mass is solid superhard material.

10. The rotor element of claim 8, wherein the unitary mass is solid polycrystalline diamond.

11. The rotor element of claim 1, further comprising a shaft extending from the exterior surface and aligned with the rotational axis.

12. The rotor element of claim 11, further comprising a holder disposed on one end of the shaft and securing the shaft to the exterior surface.

13. The rotor element of claim 11, further comprising a bearing forming a substantially point contact with the exterior surface on the rotational axis opposite from the shaft.

14. The rotor element of claim 13, wherein the bearing restricts axial translation of the exterior surface.

15. The rotor element of claim 1, further comprising:
a third edge and a forth edge disposed on opposite sides of the rotational axis; and
a second exterior surface spanning from the third edge to the forth edge, formed from a plurality of straight lines; wherein
each of the straight lines is disposed in a plane perpendicular to the rotational axis.

16. The rotor element of claim 15, wherein the exterior surface comprises a first slot therein, aligned with the rotational axis and receiving at least a portion of the second exterior surface.

17. The rotor element of claim 16, wherein the second exterior surface comprises a second slot therein, aligned with the rotational axis, receiving at least a portion of the exterior surface and mating with the first slot.

18. A method of manufacturing a rotor element, comprising:
providing a unitary mass;
providing a wire capable of degrading the unitary mass; and
engaging the unitary mass with the wire to form an exterior surface spanning between two opposing edges.

19. The method of claim 18, further comprising rotating the unitary mass about a rotational axis thereof while engaging the unitary mass with the wire.

20. The method of claim 18, wherein providing the unitary mass comprises providing a substantially cylindrical mass.
